(19) United States
(12) Patent Application Publication
(10) Pub. No.: US 2015/0304509 A1
(43) Pub. Date: Oct. 22, 2015

(54) PRINTING DEVICE, CONTROL METHOD, AND PRINTING SYSTEM

(71) Applicant: Seiko Epson Corporation, Tokyo (JP)

(72) Inventors: Kei Jintsugawa, Matsumoto-shi (JP); Hironori Maekawa, Suwa-shi (JP); Keiko Negishi, Shiojiri-shi (JP); Takeshi Komaki, Matsumoto-shi (JP)

(73) Assignee: SEIKO EPSON CORPORATION, Tokyo (JP)

(21) Appl. No.: 14/666,991

(22) Filed: Mar. 24, 2015

(30) Foreign Application Priority Data
Mar. 25, 2014 (JP) 2014-061390

(51) Int. Cl. H04N 1/00; B41J 2/165

(52) U.S. Cl. CPC H04N 1/00015; H04N 1/00405; B41J 2/165

(57) ABSTRACT

An inkjet printer enables flexibly controlling nozzle maintenance of nozzles that eject ink according to individual user needs. A printing device that prints by ejecting ink from nozzles, includes a user interface unit that receives configuration information related to a nozzle maintenance process of the nozzles; and a nozzle maintenance control unit that executes a nozzle check at a set nozzle check timing as the nozzle maintenance process when the configuration information includes information to execute a nozzle check, and information about the timing of the nozzle check to execute when a clogged nozzle having an ink ejection problem is detected.

Printing device, control method, and printing system

The instant application claims the benefit of Japanese patent application No. 2014-0613900 filed Mar. 25, 2014, the entire disclosure of which is incorporated by reference herein.

### BACKGROUND

1. Technical Field

The present disclosure relates to an inkjet printing device, and relates more particularly to a printing device that can control nozzle maintenance of nozzles that eject ink more flexibly according to individual user needs.

2. Related Art

Inkjet printers that print by ejecting colored ink from nozzles onto paper are now common. However, ink can become clogged in the nozzles of an inkjet printer depending upon the frequency of use and other factors, resulting in ink ejection problems. Nozzle maintenance processes such as cleaning (wiping) the nozzle face or flushing the nozzles at specific times are therefore used to prevent or resolve such ink ejection problems.

This maintenance process starts with a nozzle check to detect ink ejection problems from each of the nozzles.

Technology for performing this nozzle check is described in JP-A-2009-248547. The printer disclosed in JP-A-2009-248547 performs the nozzle check each time one label is printed when printing detailed images on labels, for example, but when printing text at high speed, performs the nozzle check after completing the print job.

Faulty ejection of ink from the nozzles is particularly a problem when printing a large number of print jobs continuously. For example, if a nozzle that is not ejecting ink desirably is not detected during the printing process, a large number of printouts with low print quality may be produced due to missing dots. On the other hand, throughput drops if printing is frequently interrupted to check the nozzles.

Controlling such nozzle maintenance appropriately according to the needs of the user is therefore desirable.

### SUMMARY

An objective of at least one embodiment of the present invention is to provide an inkjet printer that can flexibly control nozzle maintenance of nozzles that eject ink according to individual user needs.

One aspect of at least one embodiment of the present invention is a printing device that prints by ejecting ink from nozzles, including: a user interface unit that receives configuration information related to a nozzle maintenance process of the nozzles; and a nozzle maintenance control unit that executes a nozzle check at a set nozzle check timing when the configuration information includes information of the timing for executing a nozzle check to detect clogged nozzles having a problem ejecting ink normally, and information about whether or not to execute a nozzle check to detect clogged nozzles having a problem ejecting ink normally.

Preferably, the configuration information includes information specifying what to do when a clogged nozzle having an ink ejection problem is detected.

Further preferably, the information specifying what to do includes information declaring whether or not to report to the user that a clogged nozzle was detected; and the nozzle maintenance control unit displays a message on the user interface unit when the information specifying what to do instructs reporting to the user.

Further preferably, the user interface unit receives an instruction input by the user after displaying the message; and the nozzle maintenance control unit determines whether or not to continue printing based on the instruction.

Yet further preferably, the user interface unit sends the message information reported to the user to the host device of the printing device when the information specifying what to do instructs reporting to the user.

Another aspect of at least one embodiment of the present invention is a control method of a printing device that prints by ejecting ink from nozzles, including: receiving configuration information related to a nozzle maintenance process of the nozzles; and executing a nozzle check at a set nozzle check timing when the configuration information includes information to execute a nozzle check, and information about the timing of the nozzle check to execute when a clogged nozzle having an ink ejection problem is detected.

Another aspect of at least one embodiment of the present invention is a printing system including a host device that instructs printing, and a printing device that prints by ejecting ink from nozzles according to the printing instruction, wherein: the printing device comprises a user interface unit that receives configuration information related to a nozzle maintenance process of the nozzles, and a nozzle maintenance control unit that executes a nozzle check at a set nozzle check timing when the configuration information includes information to execute a nozzle check, and information about the timing of the nozzle check to execute when a clogged nozzle having an ink ejection problem is detected; and the host device comprises a reporting unit that receives information reporting to the user about the nozzle maintenance process from the nozzle maintenance control unit, and displays the received information to the user.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of some embodiments of a printing device according to the present invention.

FIG. 2 is a side view of the inside of a printer 2 according to some inventions.

FIG. 3 is a top view of the inside of the printer 2.

FIG. 4 shows an example of the operating panel 23.

FIG. 5 shows an example of a setup screen for the nozzle maintenance process.

FIG. 6 is a flowchart of steps in the nozzle maintenance process.

FIG. 7 shows an example of a message displayed for the user.

### DESCRIPTION OF EMBODIMENTS

Some embodiments of the present invention are described below with reference to the accompanying figures. This embodiment does not, however, limit the technical scope of the invention. Note also that identical or similar parts are identified by the same reference numerals or symbols.

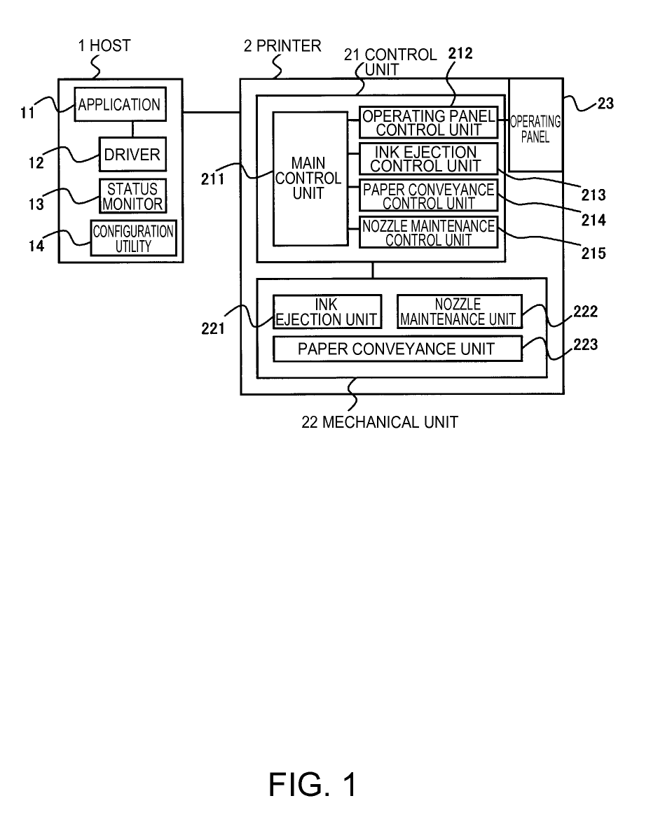

FIG. 1 is a block diagram of the configuration of a printing device according to some embodiments of the present invention. The printer 2 shown in FIG. 1 is a printing device according to some embodiments of the present invention. This printer 2 executes a nozzle maintenance process including a nozzle check during a printing process according to configuration information set in advance by the user, and executes a nozzle maintenance process accompanying the printing process to flexibly respond to individual user needs.

As shown in FIG. 1, the printer 2 according to this embodiment is an inkjet printer that executes a printing process based on a set of print data received from a host 1. The host 1 and the printer 2 embody a printing system.

The host 1 is a computer such as a personal computer, mobile terminal, or other computing device, and includes CPU, RAM, ROM, a hard disk drive, communication interface, display device, and operating device not shown. The host 1 also connects by wire or wirelessly with the printer 2.

The functional configuration of the host 1 in relation to the printer 2 includes, as shown in FIG. 1, an application 11, a driver 12, a status monitor 13, and a configuration utility 14.

The application 11 is a part that creates an image to be printed by the printer 2, and when a print request is asserted, sends data for the image to print to the driver 12.

The driver 12 is a driver for the printer 2, converts the data sent from the application 11 to print data for the printer 2, and sends the print data to the printer 2.

The status monitor 13 is apart that reports (displays) the status of the printer 2 to the user through the host 1, acquires information about the printer 2 status as needed, and displays the information on the display device of the host 1. This information may include, for example, information about the remaining amount of ink used by the printer 2, and errors that occurred in the printer 2.

The configuration utility 14 is used by the user to set the printing conditions for the printer 2 from the host 1.

Note that the application 11, driver 12, status monitor 13, and configuration utility 14 are embodied by a program defining the respectively executed processes and the CPU operating according to the program.

As described above, the printer 2 is an inkjet printer, and in this example is a line printer for continuously printing multiple labels on roll paper in a single printing process. As described above, the printer 2 has a line printhead, and starts printing the next label before printing the preceding label is completed. Note that in the nozzle maintenance process during one printing process, printing the next label does not start before printing the preceding label ends.

The printer 2 has a functional configuration as shown in FIG. 1, and has a control unit 21 that controls other parts of the printer 2, and a mechanical unit 22 that operates as controlled by the control unit 21. The printer 2 also has an operating panel 23 enabling the user to operate the printer 2 and to report information to the user.

The control unit 21 includes a CPU, ROM, RAM, NVRAM, or ASIC, not shown, for example, and is rendered as a control board.

As shown in FIG. 1, the functional configuration of the control unit 21 includes a main control unit 211, an operating panel control unit 212, an ink ejection control unit 213, a paper conveyance control unit 214, and a nozzle maintenance control unit 215.

The main control unit 211 functions as the center of the control unit 21, and centrally controls the printer 2. The operating panel control unit 212 is the part that controls the operating panel 23, and displaying information on the operating panel 23 as controlled by the main control unit 211, and sending data received through the operating panel 23 to the main control unit 211. The operating panel control unit 212 and operating panel 23 embody a user interface.

The ink ejection control unit 213 is the part that controls the ink ejection unit 221 described below, and controls ejection of ink to the paper P as controlled by the main control unit 211.

The paper conveyance control unit 214 is the part that controls the paper conveyance unit 223, and controls conveyance of the paper P synchronized to ejection of ink.

The nozzle maintenance control unit 215 is the part that controls the nozzle maintenance unit 222 described below, and controls the nozzle maintenance process of the nozzles that eject ink. The nozzle maintenance process is a process for keeping the nozzles functioning desirably, and more specifically executes a process including detecting nozzles that are not ejecting ink normally due, for example, to clogged ink (performing a nozzle check), and cleaning and flushing the nozzles to resolve the ink ejection problem. The printer 2 according to some embodiments of the present the invention is characterized by control of the maintenance process performed by the nozzle maintenance control unit 215, and the specific content of this maintenance process is described below.

Note that the processes executed by the control units 211 to 215 are rendered by a CPU operating according to a program stored in ROM, or by an ASIC, for example.

As shown in FIG. 1, the mechanical unit 22 also includes an ink ejection unit 221, a nozzle maintenance unit 222, and a paper conveyance unit 223.

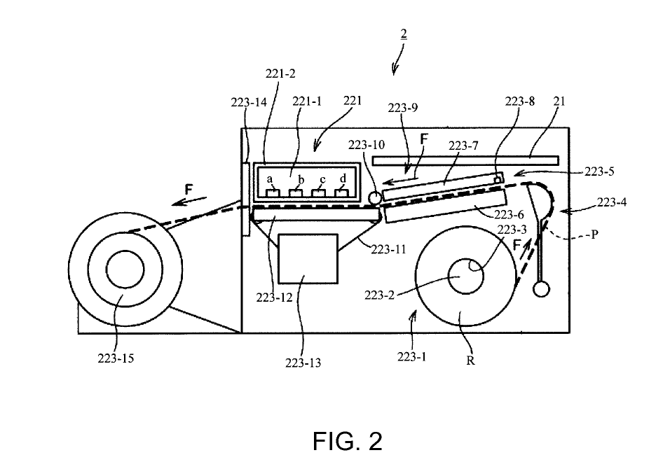

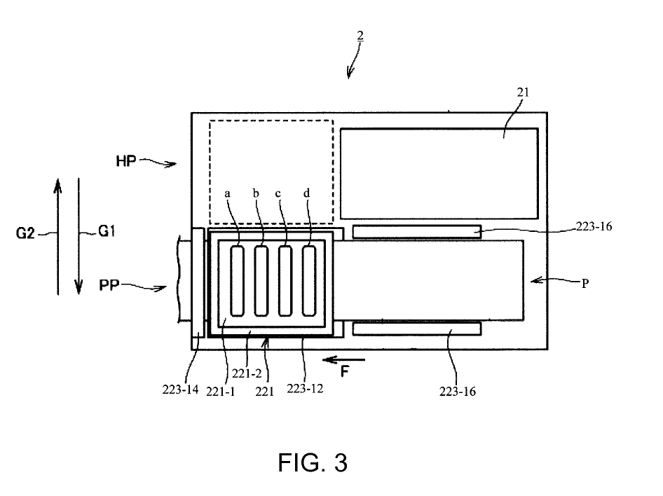

FIG. 2 is a side view of the inside of the printer 2. FIG. 3 is a plan view of the inside of the printer 2 from above.

As shown in FIG. 2 and FIG. 3, the ink ejection unit 221 has an inkjet head ink 221-1 including head units (a, b, c, d) for ejecting different colors of ink and a carriage 221-2 that carries the head units. This printer 2 is capable of full-color printing using four colors of ink, Y (yellow), M (magenta), C (cyan), and K (black), for example, and therefore has four head units (a, b, c, d) for the four colors.

Each of the head units (a, b, c, d) has a plurality of nozzles discharging a particular color of ink aligned in a row. The plural nozzles of each head unit (a, b, c, d) are arranged in a line spanning the print area of the paper P in a direction crosswise to the conveyance direction of the paper P (indicated by arrow F in the figure), thereby embodying a line printhead. Each head unit (a, b, c, d) ejects ink from the nozzles at a specific timing as controlled by the ink ejection control unit 213, and forms dots on the paper P.

As shown in FIG. 3, the carriage 221-2 is constructed to move in a direction crosswise (the direction indicated by arrows G1 and G2 in the figure) to the conveyance direction of the paper P (indicated by arrow F in the figure), and moves the inkjet head ink 221-1 between the home position HP and the printing position PP. When printing, the carriage 221-2 moves in direction G1 and positions the inkjet head ink 221-1 to the printing position PP. When printing ends and for the nozzle maintenance process, the carriage 221-2 moves in direction G2 and positions the inkjet head ink 221-1 to the home position HP.

The nozzle maintenance unit 222 also has a nozzle check device and a nozzle cleaning device. The nozzle check device may be constructed with an electrode that charges the ink particles ejected from the nozzles, and a conductor on which the ink particles ejected from the nozzles land, and outputs an electrical signal flowing through the conductor to a specific signal processing circuit. When performing a nozzle check, a specific amount of ink particles are ejected from the nozzle being checked, the ejected ink particles are charged with a specific charge by the electrode, and land on the conductor. The state of the current flowing through the conductor changes according to the ink particles landing, and a signal representing the change is output through the specific signal processing circuit to the nozzle maintenance control unit 215.

When the value indicated by the input signal exceeds a specific threshold, the nozzle maintenance control unit 215 determines that the expected amount of ink was normally ejected and there is not an ink ejection problem with that nozzle. However, if the value indicated by the input signal is less than the specific threshold, the nozzle maintenance control unit 215 determines that the expected amount of ink was not normally ejected for some reason and that there is an ink ejection problem with that nozzle.

Using this method, the nozzle maintenance control unit 215 can check all nozzles in the inkjet head for missing dots.

The method used for the nozzle maintenance process is not limited to the foregoing. For example, ink may be ejected from the target nozzle onto paper P to form dots and the formed dots read optically to determine if there is an ink ejection problem with the target nozzle. Further alternatively, the signal wave of the control signal driving the actuator that ejects ink may be monitored to determine whether or not there is an ejection problem, for example.

The cleaning device includes a head cap, suction tub, suction selection valve, and suction pump not shown, and executes a cleaning operation that forcibly suctions ink from inside of nozzles of the inkjet head ink 221-1. Other types of cleaning devices that remove ink clogged inside the nozzles may obviously be used instead.

The nozzle maintenance unit 222 also executes a flushing operation as needed. The flushing operation is an operation performed to suppress increase in the viscosity of ink inside the nozzles. In the flushing operation, the nozzle maintenance control unit 215 ejects a specific amount of ink a specific number of times from the nozzles into the head cap (not shown in the figure), replacing the ink inside the nozzles with new ink.

The paper conveyance unit 223 is a device that moves the paper P from where it is stored to the print position, and then discharges the paper P from the printer 2. As shown in FIG. 2 and FIG. 3, the paper conveyance unit 223 includes a roll paper storage compartment 223-1, a roll paper spindle 223-2 that is inserted to the core 223-3 of the paper roll R, a tension lever 223-4 that applies tension to the paper P pulled from the paper roll R set in the roll paper storage compartment 223-1, and a lower paper guide 223-6, upper paper guide 223-7, and side paper guide 223-16 forming a paper guide 223-9 for the paper P on the paper roll R conveyance path 223-5. The paper conveyance unit 223 also has a platen 223-12 disposed to a position opposite the inkjet head ink 221-1; a conveyance roller 223-10, conveyance belt 223-11, and conveyance unit 223-13 that convey the paper P disposed therebetween; a paper detector 223-8 that detects the paper P; a cutter unit 223-14 that cuts the paper P; and a take-up drum 223-15 that takes up the paper P after printing.

The paper P is conveyed in the direction indicated by arrow F in FIG. 2 and FIG. 3 by the paper conveyance unit 223.

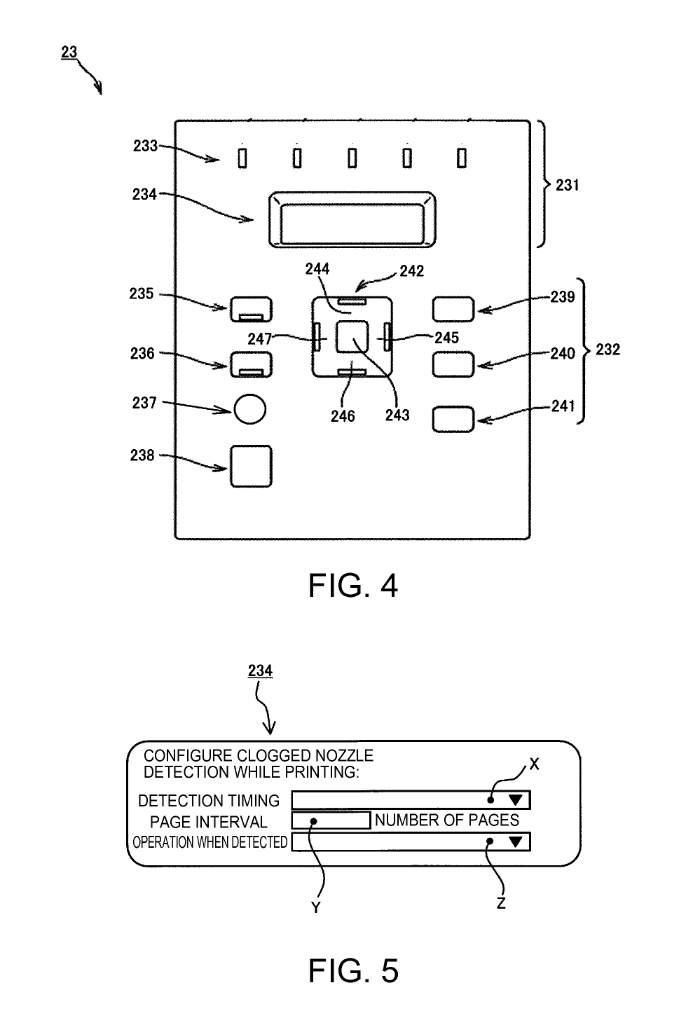

FIG. 4 shows an example of the operating panel 23. As shown in FIG. 4, the operating panel 23 has an LED unit 233 and a display 234 in the display area 231. The on/off status of the power supply, and the operating status of the printer 2, for example, are displayed in the LED unit 233.

The operating area 232 includes a pause switch 235 for temporarily interrupting printing; a back switch 236 for moving back through the hierarchy of menu items displayed in the display 234; a cancel button 237 for cancelling printing; a power switch 238 for turning the power on and off; a forward feed switch 239 for feeding the paper P forward in the conveyance direction; a back-feed switch 240 for feeding the paper P in the reverse conveyance direction of the paper P; an auto cut switch 241 for cutting the paper P; and a cursor 242 for making a selection from a menu displayed in the display 234. The cursor 242 includes a selection switch 243, up switch 244, right switch 245, down switch 246, and a left switch 247.

Each time print data is received from the host 1, the printer 2 according to this embodiment thus comprised executes an operation conveying the paper P by the paper conveyance unit 223, and an ink ejection operation by the ink ejection unit 221, as controlled by the control unit 21 to print the print data.

As described above, the printer 2 according to this embodiment is characterized by control of the nozzle maintenance process, and the specific operation in this process is described below.

User settings related to the nozzle maintenance process are described first. The according to this embodiment has a function enabling the user preconfigure the nozzle maintenance process so that the nozzle check process and cleaning process are performed as desired by the user.

More specifically, in response to a specific operation of the user on the operating panel 23, the operating panel control unit 212 displays a setup screen related to the nozzle maintenance process on the display 234 of the operating panel 23.

FIG. 5 shows an example of this setup screen. The example shown in FIG. 5 provides tools enabling the user to set the detection timing, the page interval for detection, and the operation to perform when a nozzle with an ink ejection problem (referred to for convenience as a clogged nozzle) is detected. This configuration operation is done using the cursor 242 of the operating panel 23.

The detection timing is the timing when the nozzle check operation is performed during the printing process, and the timing in this example can be set (selected) to None or a specific Page Interval using a popup menu X as shown in FIG. 5. None means that a nozzle check will not be performed during the printing process. Selecting a Page Interval means that the nozzle check will be performed each time the number of pages set in the Page Interval field is printed.

As described above, the Page Interval indicates how frequently the nozzle check is performed during the printing process, and a number of pages from 1 (1 page) to 500 (500 pages), for example, can be set in the Page Interval field Y shown in FIG. 5. If set to 100, the nozzle check is performed every time 100 pages are printed. If the detection timing is set to None, a value is not set in the Page Interval field.

Note also that the printer 2 in this embodiment is a line printer that prints multiple labels continuously, and the Page Interval corresponds to the label interval. More specifically, if the Page Interval is set to 100, the nozzle check is performed every time 100 labels are printed.

The Operation When Detected means the operation the printer performs when an ink ejection problem (clogged nozzle) is detected in the nozzle check during the printing process. In this example, either Report or Continue Printing can be set (selected) from the Operation When Detected field Z in FIG. 5. A report is issued to the user if Report is selected, and the printing process continues if Continue Printing is selected. The specific content of these operations is described further below.

When these settings are made, the operating panel control unit 212 stores the settings made through the operating panel in memory (such as NVRAM) of the control unit 21.

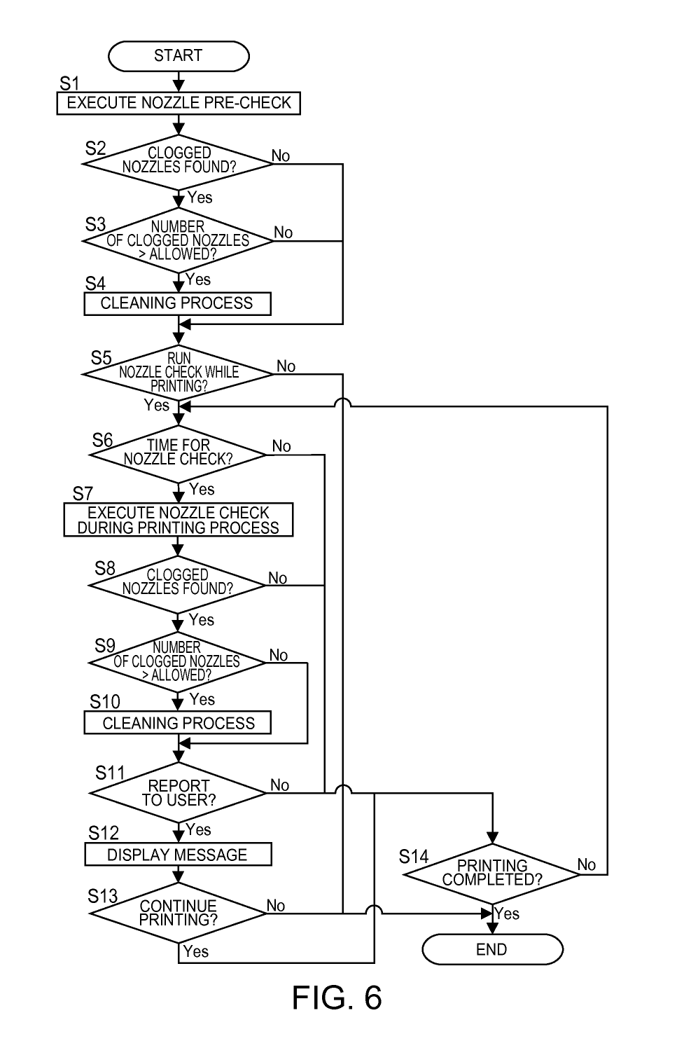

Control of the nozzle maintenance process based on the stored settings is described next. FIG. 6 is a flow chart of steps in an exemplary nozzle maintenance process. The nozzle maintenance process in one printing process is described below with reference to FIG. 6.

One printing process as used here means a printing process based on a group of print data received from the host 1 without a gap (pause) of a specific time (such as 3 seconds), and below is referred to as simply one printing process. One printing instruction (transmission of print data) from the host 1 is referred to as one job, and when plural jobs are sent continuously with a short interval therebetween, the printer 2 may handle the plural jobs as one printing process. Alternatively, the process of one job may be treated as one printing process.

The nozzle maintenance control unit 215 executes a nozzle pre-check before starting the one printing process (step S1 in FIG. 6). More specifically, the nozzle maintenance control unit 215 drives the nozzle maintenance unit 222 to execute the nozzle check operation described above to check the nozzles. This nozzle check may be applied to all nozzles or only specific nozzles.

If there are no nozzles detected with an ink ejection problem in this nozzle check (step S2 in FIG. 6 returns NO), control goes to step S5.

If nozzles with an ink ejection problem (a clogged nozzle) are detected in this nozzle check (step S2 in FIG. 6 returns YES), the nozzle maintenance control unit 215 compares the number of clogged nozzles detected with a predetermined threshold (step S3 in FIG. 6). This threshold is the number of clogged nozzles in one nozzle row in the direction crosswise to the paper conveyance direction, and is set to a value from 0 to 10, for example. Note that this threshold may be included in the configuration settings described above and set by the user.

If the result of this comparison is that the number of clogged nozzles is less than the threshold (step S3 in FIG. 6 returns NO), control goes to step S5.

If the result of this comparison is that the number of clogged nozzles exceeds the threshold (step S3 in FIG. 6 returns YES), the nozzle maintenance control unit 215 executes the cleaning process (step S4 in FIG. 6). More specifically, the nozzle maintenance control unit 215 drives the nozzle maintenance unit 222 to execute the cleaning process.

Note that the maintenance process invoked by the nozzle pre-check described above is always executed before the one printing process, but a configuration in which the user sets whether or not to execute this maintenance process is also conceivable. In this event, the nozzle maintenance control unit 215 references the stored configuration information and does not execute the maintenance process related to the nozzle pre-check in step S1 to S4 if Do Not Execute is selected.

Next, the nozzle maintenance control unit 215 starts the maintenance process during the printing process and determines whether or not to execute the nozzle check during the printing process (step S5 in FIG. 6). More specifically, the nozzle maintenance control unit 215 makes this decision based on the information related to the Detection Timing setting in the configuration information input and stored in memory by the setup operation of the user described above.

If the referenced configuration setting is None, meaning to not execute the nozzle check during the printing process, the nozzle maintenance control unit 215 decides to not execute the maintenance process during the printing process (step S5 in FIG. 6 returns NO), and ends the maintenance process for the one printing process.

However, if the configuration setting is set to Page Interval, meaning that the nozzle check is to be done during the printing process, the nozzle maintenance control unit 215 knows to execute the maintenance process during the printing process (step S5 in FIG. 6 returns YES), and determines if it is time to run the nozzle check (step S6 in FIG. 6). The nozzle maintenance control unit 215 makes this decision based on the value set in the Page Interval setting in the user's configuration settings. More specifically, the nozzle maintenance control unit 215 determines if the printing process has been executed for the number of pages in the Page Interval setting since the last time the nozzle check was done based on the number of pages printed in the printing process acquired by querying the main control unit 211.

If the decision is that a printing process has not been executed for the number of pages in the Page Interval setting since the last time the nozzle check was done, the nozzle maintenance control unit 215 determines it is not time to execute the nozzle check (step S6 in FIG. 6 returns NO), and control goes to step S14.

However, if the decision is that the printing process has been executed for the number of pages in the Page Interval setting since the last time the nozzle check was done, the nozzle maintenance control unit 215 determines it is time to execute the nozzle check (step S6 in FIG. 6 returns YES), and executes the nozzle check during the printing process (step S7 in FIG. 6). More specifically, the nozzle maintenance control unit 215 drives the nozzle maintenance unit 222 to execute the nozzle check operation described above and checks the nozzles. This nozzle check may be applied to all nozzles or only specific nozzles.

If there are no nozzles detected with an ink ejection problem in this nozzle check (step S8 in FIG. 6 returns NO), control goes to step S14.

If nozzles with an ink ejection problem (a clogged nozzle) are detected in this nozzle check (step S8 in FIG. 6 returns YES), the nozzle maintenance control unit 215 compares the number of clogged nozzles detected with a predetermined threshold (step S9 in FIG. 6). This threshold may be the same as the number of clogged nozzles used for comparison in step S3 above.

If the result of this comparison is that the number of clogged nozzles is less than the threshold (step S9 in FIG. 6 returns NO), control goes to step S11.

If the result of this comparison is that the number of clogged nozzles exceeds the threshold (step S9 in FIG. 6 returns YES), the nozzle maintenance control unit 215 executes the cleaning process (step S10 in FIG. 6). More specifically, the nozzle maintenance control unit 215 drives the nozzle maintenance unit 222 to execute the cleaning process.

The nozzle maintenance control unit 215 then executes the operation set for when clogged nozzles are detected based on the user configuration settings described above. More specifically, the nozzle maintenance control unit 215 determines whether to report to the user, or whether to continue printing without reporting to the user (step S11 in FIG. 6). The nozzle maintenance control unit 215 makes this decision by referencing the value set as the Operation When Detected in the user configuration information described above. If the Operation When Detected value is set to Continue Printing (step S11 in FIG. 6 returns NO), control goes to step S14.

If the Operation When Detected value is set to Report (step S11 in FIG. 6 returns YES), the nozzle maintenance control unit 215 executes a user reporting process. More specifically, the nozzle maintenance control unit 215 executes a process to display a message for the user through the operating panel control unit 212 (step S12 in FIG. 6).

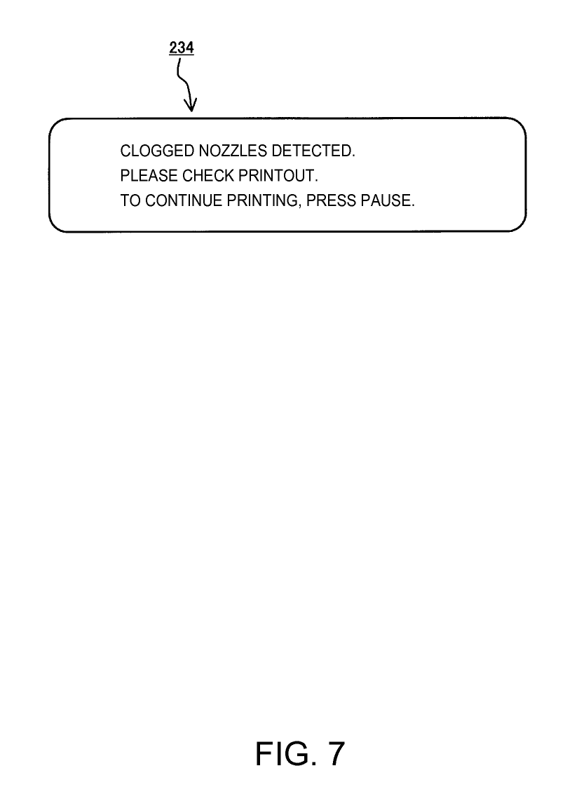

FIG. 7 shows an example of a message presented to the user. A sample message displayed in the display 234 of the operating panel 23 of the printer 2 is shown in FIG. 7. By reading this message, the user is prompted to examine the pages printed to that point and determine whether or not to continue printing. Note that this message may also be displayed on the host 1. In this event, the nozzle maintenance control unit 215 sends the same message to the status monitor 13 (reporting unit) of the host 1. When the message is received, the status monitor 13 displays the message on the display device of the host 1. As a result, the report can be quickly presented to the user when the user is at the host 1 and not the printer 2.

After displaying the message, the nozzle maintenance control unit 215 waits for a user operation on the operating panel 23 and determines if the operation means to continue printing (step S13 in FIG. 6). When the user reads the message, checks the printed pages, and determines there is no particular problem and chooses to continue printing, the user presses the pause switch 235 on the operating panel 23. Because the nozzle maintenance process is performed at the home position HP as described above, the printing process is temporarily interrupted (stopped) by the main control unit 211 for the nozzle maintenance process. The pause in the printing process is thereby cancelled by pressing the pause switch 235, and printing is continued. In this event, the nozzle maintenance control unit 215 gets information from the main control unit 211 indicating that printing continues, determines that the user instructing continuing printing (step S13 returns YES), and control goes to step S14.

However, if the user determines to stop printing at that point as a result of examining the printout, the user presses the cancel button 237 on the operating panel 23. This information is also sent to the main control unit 211, and the main control unit 211 therefore knows that printing was cancelled. In this event, the nozzle maintenance control unit 215 gets information from the main control unit 211 that the printing process was cancelled, knows that the user operation instructed to not continue printing (step S13 in FIG. 6 returns NO), and ends the nozzle maintenance process.

Step S14 causes the nozzle maintenance control unit 215 to repeat the process from step S6 (step S14 in FIG. 6 returns NO) until information indicating that the one printing process ended is received from the main control unit 211.

When information indicating that the one printing process ended is received from the main control unit 211 (step S14 in FIG. 6 returns YES), the nozzle maintenance control unit 215 ends the nozzle maintenance process.

User settings related to the nozzle maintenance process may also be made from the host 1. In this event this function is handled by the configuration utility 14 (settings and instruction unit), and the configuration utility 14 displays a configuration screen such as shown in the example in FIG. 5 on the display device of the host 1 in response to a user operation, and sends the information input to the screen to the printer 2. The printer 2 then stores and uses the sent information as the configuration settings in the nozzle maintenance process.

When the user report is sent to the host 1 (step S12) when clogged nozzles are detected during the printing process, the user operation in response to the report (continuing printing or stopping the printing process) may be made from the host 1 side. In this event, the status monitor 13 or the configuration utility 14 (settings and instruction unit) handles this function, and displays the operation selection screen on the display device of the host 1. When a selection is made through this screen, the operation selected by the user (continuing printing or stopping the printing process) is sent to the printer 2. The printer 2 then performs the operation based on the received selection in the same way as when the operation is selected on the printer 2.

As described above, the printer 2 according to this embodiment executes a nozzle maintenance process during the printing process according to the process configuration previously made by the user. Individual user needs can therefore be flexibly accommodated.

The user configuration settings include information about executing or not executing the nozzle maintenance process, the timing when the nozzle maintenance process is to be executed, and the action to take when clogged nozzles are detected, and enable executing the nozzle maintenance process appropriately according to whether to prioritize the quality of the printout or prioritize the printing speed.

Furthermore, because the user is asked whether or not to continue printing when clogged nozzles are detected during the printing process, and operation proceeds according to the user response, an appropriate response can be made according to the printing conditions at that time. As a result, a flexible response based on the user needs can be made, and unnecessary or wasteful printing can be prevented.

Printing system convenience can also be improved by enabling user configuration of the nozzle maintenance process and issuing user instructions from the host 1 side.

The disclosure being thus described, it will be apparent that it may be varied in many ways. Such variations are not to be regarded as a departure from the spirit and scope of the disclosure, and all such modifications as would be apparent to one skilled in the art are intended to be included within the scope of the following claims.

What is claimed is:

1. A printing device that prints by ejecting ink from nozzles, comprising:
a user interface unit that receives configuration information related to a nozzle maintenance process of the nozzles; and
a nozzle maintenance control unit that executes a nozzle check at a set nozzle check timing when the configuration information includes information to execute a nozzle check, and information about the timing of the nozzle check to execute when a clogged nozzle having an ink ejection problem is detected.

2. The printing device described in claim 1, wherein:
the configuration information includes information specifying what to do when a clogged nozzle having an ink ejection problem is detected.

3. The printing device described in claim 2, wherein:
the information specifying what to do includes information declaring whether or not to report to the user that a clogged nozzle was detected; and
the nozzle maintenance control unit displays a message on the user interface unit when the information specifying what to do instructs reporting to the user.

4. The printing device described in claim 3, wherein:
the user interface unit receives an instruction input by the user after displaying the message; and
the nozzle maintenance control unit determines whether or not to continue printing based on the instruction.

5. The printing device described in claim 3, wherein:
the user interface unit sends the message information reported to the user to the host device of the printing device when the information specifying what to do instructs reporting to the user.

6. A control method of a printing device that prints by ejecting ink from nozzles, comprising:
receiving configuration information related to a nozzle maintenance process of the nozzles; and
executing a nozzle check at a set nozzle check timing when the configuration information includes information to execute a nozzle check, and information about the timing of the nozzle check to execute when a clogged nozzle having an ink ejection problem is detected.

7. The control method described in claim 6, wherein:
the configuration information includes information specifying what to do when a clogged nozzle having an ink ejection problem is detected.

8. The control method described in claim 7, further comprising:
displaying a message when the information specifying what to do includes information to report to the user that a clogged nozzle was detected.

9. The control method described in claim 7, further comprising:
receiving an instruction input by the user after displaying the message; and
determining whether or not to continue printing based on the instruction.

10. The control method described in claim 8, further comprising:
sending the message information reported to the user to the host device of the printing device when the information specifying what to do instructs reporting to the user.

11. A printing system including a host device that instructs printing, and a printing device that prints by ejecting ink from nozzles according to the printing instruction, wherein:
the printing device comprises a user interface unit that receives configuration information related to a nozzle maintenance process of the nozzles, and
a nozzle maintenance control unit that executes a nozzle check at a set nozzle check timing when the configuration information includes information to execute a nozzle check, and information about the timing of the nozzle check to execute when a clogged nozzle having an ink ejection problem is detected; and
the host device comprises a reporting unit that receives information reporting to the user about the nozzle maintenance process from the nozzle maintenance control unit, and displays the received information to the user.

12. The printing system described in claim 12, wherein:
the configuration information includes information specifying what to do when a clogged nozzle having an ink ejection problem is detected.

13. The printing system described in claim 12, wherein:
the information specifying what to do includes information declaring whether or not to report to the user that a clogged nozzle was detected; and
the nozzle maintenance control unit displays a message on the user interface unit when the information specifying what to do instructs reporting to the user.

14. The printing system described in claim 13, wherein:
the user interface unit receives an instruction input by the user after displaying the message; and
the nozzle maintenance control unit determines whether or not to continue printing based on the instruction.

15. The printing system described in claim 13, wherein:
the user interface unit sends the message information reported to the user to the host device when the information specifying what to do instructs reporting to the user.

16. The printing system described in claim 11, wherein:
the host device has a settings and instruction unit that receives information including the configuration information and an instruction about display by the reporting unit input by the user, and sends the received information to the printer.
